(19) United States
(12) Patent Application Publication
(10) Pub. No.: US 2026/0360204 A1
(43) Pub. Date: Nov. 12, 2026

(54) IMAGE PROCESSING METHOD FOR GAME SYSTEM, GAME SYSTEM, AND PROCESSING DEVICE OF GAME SYSTEM

(71) Applicant: NEXTEQ PLC, Cambridge (GB)

(72) Inventor: CHIEN-SHEN TSAI, NEW TAIPEI CITY (TW)

(21) Appl. No.: 19/315,634

(22) Filed: Aug. 31, 2025

(30) Foreign Application Priority Data
May 12, 2025 (TW) 114117648

(51) Int. Cl. G07F 17/32

(52) U.S. Cl. CPC G07F 17/3211; G07F 17/3227

(57) ABSTRACT

An image processing method for game system, a game system, and a processing device for a game system are provided. The image processing method includes: an image copying step, a transfer step, a first image capture step, a first output step, and an image processing program being executed N-1 times. The image copying step: using a first image chip, so that a source screen can be replicated into N-1 copy images. The first image capture step: using the first image chip to crop the source screen according to a first preset coordinate region to extract a first screen image. Each time the image processing program is executed, the second image chip can cut the N-1 copy image according to a second preset coordinate region to capture a second screen image. N output screens included in the game system display the first screen image and N-1 second screen images.

### CROSS-REFERENCE TO RELATED PATENT APPLICATION

This application claims the benefit of priority to Taiwan Patent Application No. 114117648, filed on May. 12, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an image processing method, and more particularly to an image processing method for game system, a game system, and a processing device of a game system.

### BACKGROUND OF THE DISCLOSURE

A conventional game system has a plurality of display screens, and each of the display screens can show a different game image. For an admin managing the conventional game system, preventing any of the game images displayed on the display screens from being tampered with is a critical issue that must be addressed. When a game image can be altered, issues of unfairness and injustice may be introduced into the game. Furthermore, in order for the admin to increase the number of displays in the conventional game system, additional graphics cards need to be purchased, which results in increased costs.

### SUMMARY OF THE DISCLOSURE

In response to the above-referenced technical inadequacies, the present disclosure provides an image processing method for game system, a game system, and a processing device of a game system, which are mainly used to improve the problem that a game image displayed on any one of a plurality of display screens of the conventional game system can be easily tampered with, and an increased cost incurred when admins are forced to purchase additional graphics cards to meet the demand for more displays.

In order to solve the above-mentioned problems, one of the technical aspects adopted by the present disclosure is to provide an image processing method for a game system. The image processing method is applicable to be executed by a processing device of the game system. The game system includes N number of output screens, and N is a positive integer greater than 1. The processing device includes a first image chip and N–1 number of second image chips. The first image chip is electrically connected to each of the N–1 second image chips. The processing device is configured to execute the image processing method upon receiving a source screen including N number of game images that do not overlap with each other. The image processing method includes an image copying step and a transfer step. The image copying step is implemented by executing a first default firmware of the first image chip so as to copy the source screen to generate N-1 number of copy images. The transfer step is implemented by executing the first default firmware of the first image chip, so that the N-1 copy images are respectively transmitted to the N–1 second image chips. After the transfer step, the image processing method further includes a first image capture step and a first output step. The first image capture step is implemented by executing the first default firmware of the first image chip to crop the source screen according to a first preset coordinate region, so as to capture a first screen image. The first output step is implemented by executing the first default firmware of the first image chip, so as to output the first screen image to one of the output screens connected to the first image chip. After the transfer step, the image processing method further includes: executing the image processing program N–1 number of times through a second default firmware of the N–1 second image chips, wherein each time the image processing program is executed. The image processing program includes a second image capture step and a second output step. The second image capture step is implemented by executing a second default firmware of one of the N–1 second image chips to crop a corresponding one of the N-1 copy images, so as to capture a second screen image according to a second preset coordinate region. The second output step is implemented by executing the second default firmware of the second image chip, so that the second screen image is configured to be output to one of the output screens that is connected to the second image chip. The second preset coordinate region in (N−1)th second image capture step and the first preset coordinate region in the first image capture step do not overlap with each other. The first screen image and the N-1 second screen images corresponding to the first output step and (N-1)th second output step are output to the N output screens, and the N output screens display N number of game images.

In order to solve the above-mentioned problems, another one of the technical aspects adopted by the present disclosure is to provide a game system. The game system includes a main body, a central processing device, at least one input device, N number of output screens, and a processing device. The central processing device includes an internal display chip. The at least one input device is disposed on the main body. The at least one input device is configured to be used to provide for user operation. The N output screens are disposed in the main body. N is a positive integer greater than 1. The processing device is electrically connected to the central processing device, and includes a first image chip and N-1 number of second image chips. The first image chip is configured to receive a source screen transmitted by the central processing device. The source screen includes N number of game images that do not overlap with each other. Each of the N-1 second image chips is electrically connected to the first image chip. One of the N output screens is connected to the first image chip, and N-1 number of output screens are respectively connected to the N–1 second image chips. After receiving the source screen, the processing device is configured to include an image copying step and a transfer step. The image copying step is implemented by executing a first default firmware of the first image chip so as to copy the source screen to generate N-1 number of copy images. The transfer step is implemented by executing the first default firmware of the first image chip, so that the N-1 copy images are respectively transmitted to the N–1 second image chips. After the transfer step, the processing device further includes a first image capture step and a first output step. The first image capture step is implemented by executing the first default firmware of the first image chip to crop the source screen according to a first preset coordinate region, so as to capture a first screen image. The first output step is implemented by executing the first default firmware of the first image chip, so as to output the first screen image to one of the output screens connected to the first image chip. After the transfer step, the processing device further includes: executing the image processing program N–1 number of times through a second default firmware of the N–1 second image chips. Each time the image processing program is executed, the image processing program includes a second image capture step and a second output step. The second image capture step is implemented by executing a second default firmware of one of the N–1 second image chips to crop a corresponding one of the N-1 copy images, so as to capture a second screen image according to a second preset coordinate region. The second output step is implemented by executing the second default firmware of the second image chip, so that the second screen image is configured to be output to one of the output screens that is connected to the second image chip. The second preset coordinate region in (N−1)th second image capture step and the first preset coordinate region in the first image capture step do not overlap with each other. The first screen image and the N-1 second screen images corresponding to the first output step and (N-1)th second output step are output to the N output screens, and the N output screens display N number of game images.

In order to solve the above-mentioned problems, yet another one of the technical aspects adopted by the present disclosure is to provide a processing device for a game system. The processing device is applicable to be executed by a processing device of the game system, and the processing device of the game system is electrically connected to N number of output screens of the game system. The processing device of the game system includes a first image chip and N-1 number of second image chips. The first image chip is configured to receive a source screen. The source screen includes N number of game images that do not overlap with each other. Each of the N-1 second image chips is electrically connected to the first image chip. One of the N output screens is connected to the first image chip, and N-1 number of output screens are respectively connected to the N–1 second image chips. After receiving the source screen, the processing device is configured to include an image copying step and a transfer step. The image copying step is implemented by executing a first default firmware of the first image chip so as to copy the source screen to generate N-1 number of copy images. The transfer step is implemented by executing the first default firmware of the first image chip, so that the N-1 copy images are respectively transmitted to the N–1 second image chips. After the transfer step, the processing device further includes a first image capture step and a first output step. The first image capture step is implemented by executing the first default firmware of the first image chip to crop the source screen according to a first preset coordinate region, so as to capture a first screen image. The first output step is implemented by executing the first default firmware of the first image chip, so as to output the first screen image to one of the output screens connected to the first image chip. After the transfer step, the processing device further includes: executing the image processing program N–1 number of times through a second default firmware of the N–1 second image chips. Each time the image processing program is executed, the image processing program includes a second image capture step and a second output step. The second image capture step is implemented by executing a second default firmware of one of the N–1 second image chips to crop a corresponding one of the N-1 copy images, so as to capture a second screen image according to a second preset coordinate region. The second output step is implemented by executing the second default firmware of the second image chip, so that the second screen image is configured to be output to one of the output screens that is connected to the second image chip. The second preset coordinate region in (N−1)th second image capture step and the first preset coordinate region in the first image capture step do not overlap with each other. The first screen image and the N-1 second screen images corresponding to the first output step and (N-1)th second output step are output to the N output screens, and the N output screens display N number of game images.

Therefore, in the image processing method, the game system, and the processing device, provided by the present disclosure, by virtue of “the first image chip, the second image chip, the image copying step, the transfer step, the first image capture step, the first output step, the second image capture step, and the second output step,” the image processing method, the game system, and the processing device can ensure that the game images presented by each of the output screens of the game system are not easily tampered with, so as to ensure the fairness and impartiality of the game. Moreover, the image processing method, the game system, and the processing device can enable relevant admins to increase a quantity of output screens of the game system without the need to purchase additional graphics cards.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a game system according to a first embodiment of the present disclosure;

FIG. 2 is a block diagram of the game system according to the first embodiment of the present disclosure;

FIG. 3 is a schematic view of a source screen of the game system according to the present disclosure;

FIG. 4 is a flowchart of an image processing method for the game system according to the first embodiment of the present disclosure;

FIG. 5 is a block diagram of the game system according to a second embodiment of the present disclosure; and

FIG. 6 is a flowchart of the image processing method for the game system according to the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

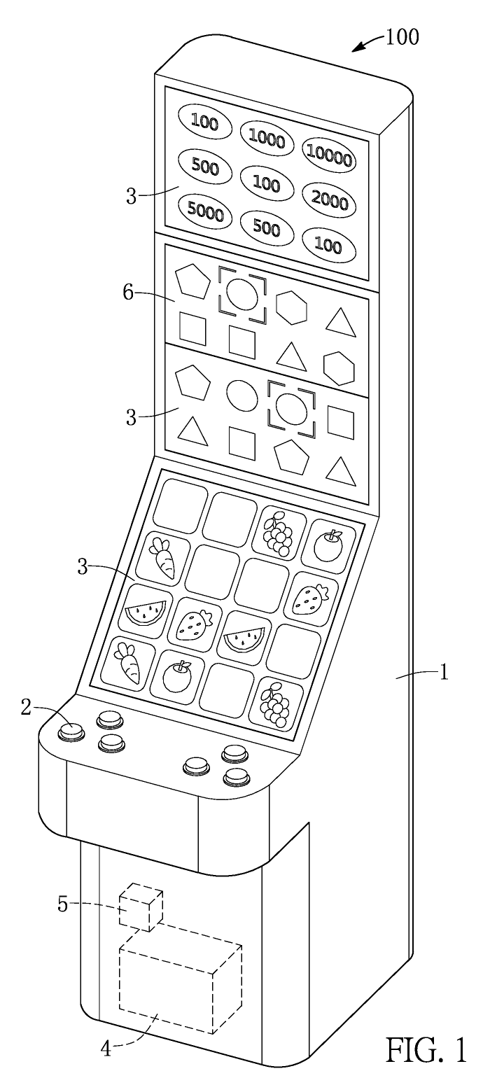

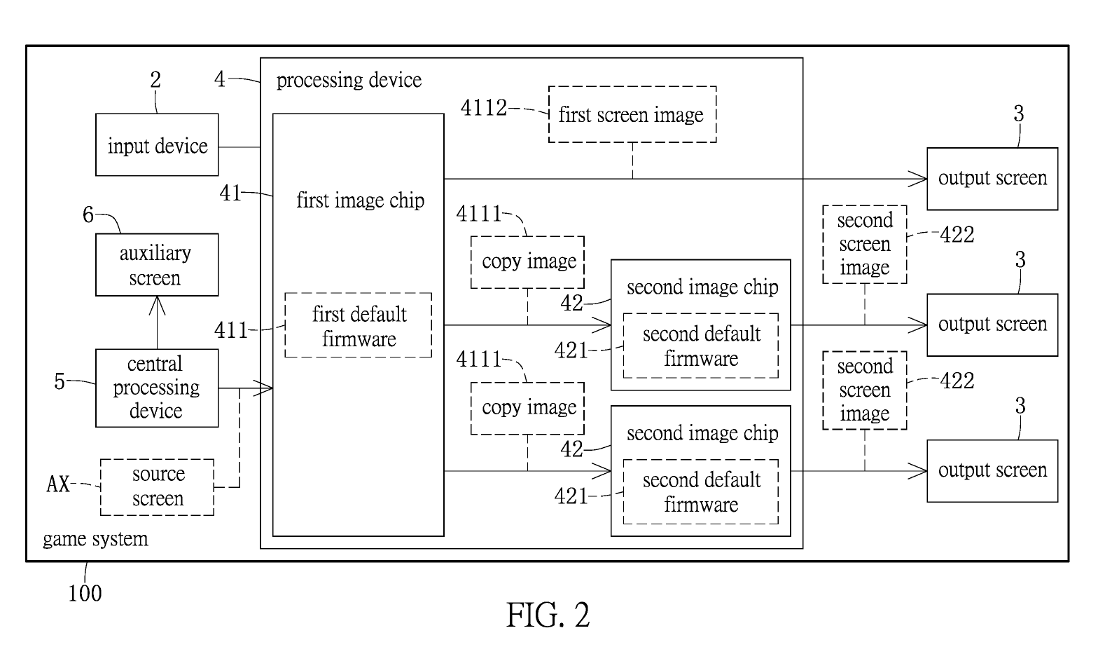

Referring to FIGS. 1 and 2, the game system 100 of the present disclosure includes a main body 1, at least one input device 2, N number of output screens 3, a processing device 4, a central processing device 5, and an auxiliary screen 6. The main body 1 is a main supporting structure and a main appearance structure of the game system 100. The input device 2 can be exemplified to a joystick, a button, a touch screen, etc., any input device that can provide user operations to input operation instructions. N is a positive integer greater than 1. In the drawings of the present embodiment, N can be exemplified to be 3, but the present disclosure is not limited thereto. An appearance of the main body 1 of the game system 100, a quantity of the at least one input device 2, and a quantity of the output screens 3 can be adjusted according to practical requirements. The configuration shown in the drawings is merely one exemplary embodiment. The central processing device 5 is a main processing device of the game system 100. The central processing device 5 can be exemplified to include a motherboard, a central processing unit (CPU), etc., and has a plurality of image output connectors on the motherboard. The central processing device 5 includes an internal display chip. The central processing device 5 is electrically connected to the auxiliary screen 6, and the central processing device 5 can control the auxiliary screen 6 to display a game image. It should be noted that the central processing device 5 uses the internal display chip to control the auxiliary screen 6 to display the game image.

The processing device 4 includes a first image chip 41 and N-1 second image chips 42. In the present embodiment, the game system 100 includes three output screens 3, and the processing device 4 correspondingly includes a first image chip 41 and two second image chips 42, that is, a total quantity of the first image chip 41 and the second image chip 42 included in the processing device 4 is basically the same as a quantity of output screen 3. In one specific example, the first image chip 41 and the second image chip 42 may be chips of model RTD2785, or similar chips, but the present disclosure is not limited thereto. In practice, the first image chip 41 and the second image chip 42 may be chips of the same model. However, the present disclosure is not limited thereto and may be adjusted according to practical requirements.

The first image chip 41 is used to receive a source screen AX transmitted by the central processing device 5, and the source screen AX includes N number of game images A1 that do not overlap with each other. In the present embodiment, N is 3, so that the source screen AX correspondingly includes three game images A1. The first image chip 41 can be exemplified to receive the source screen AX by wired or wireless means. In practice, the processing device 4 may include a plurality of image connectors (e.g., High-Definition Multimedia Interface connectors, DisplayPort connectors, etc.), and the processing device 4 can be connected to the image connectors of the circuit board connected to the central processing device 5 through a connecting line to obtain the source screen AX.

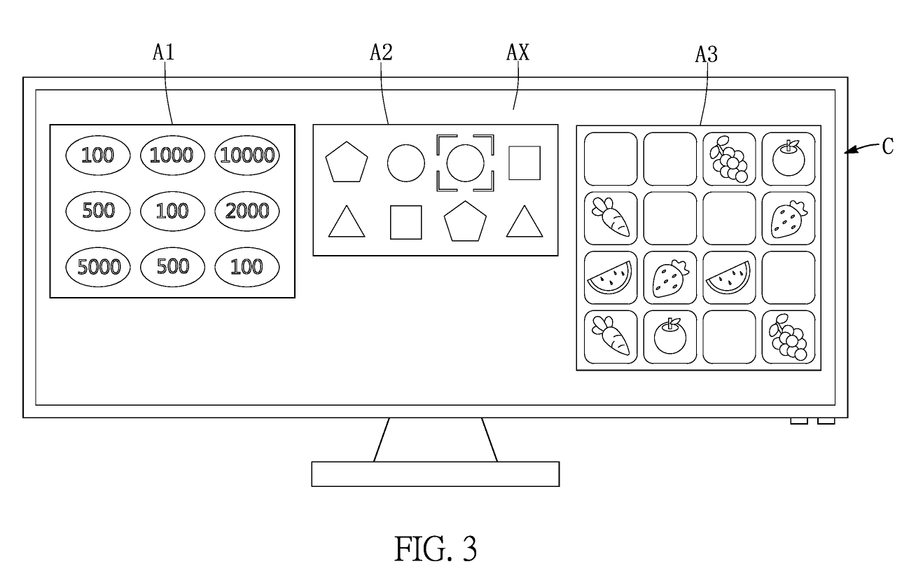

Referring to FIGS. 1 and 3, is a schematic view of the source screen AX displayed on a display device C connected to the central processing device 5. In the present embodiment, the source screen AX includes three game images A1, A2, and A3, and the three game images A1, A2, and A3 do not overlap with each other. In actual applications, each of the game images included in any one of the source screens AX is designed and planned by the game designer. As shown in FIG. 1, the three game images A1, A2, and A3 included in the source screen AX will eventually and respectively be presented on the three output screens 3 of the game system 100. The game image displayed by the auxiliary screen 6 is different from the game image included in source screen AX.

Referring to FIG. 2, the first image chip 41 is also electrically connected to one of the three output screens 3. Each of the two second image chip 42 is electrically connected to the first image chip 41, and the two second image chips 42 are electrically connected to two of the three output screens 3, and the three output screens 3 are respectively connected to the first image chip 41 and the two second image chips 42. In other words, the three output screens and the three image chips (i.e., one first image chip 41 and two second image chips 42) are connected one to one.

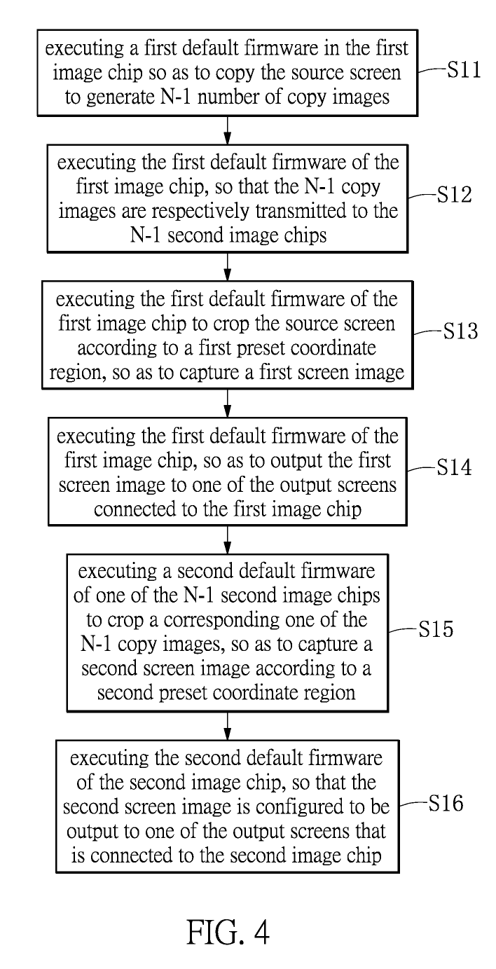

Referring to FIGS. 2 and 4, after receiving the source screen AX, the processing device 4 is capable of executing the image processing method for the game system in the present disclosure. The image processing method in the present disclosure includes the following steps:

An image copying step S11 is implemented by executing a first default firmware 411 in the first image chip 41 so as to copy the source screen AX to generate N-1 number of copy images 4111.
A transfer step S12 is implemented by executing the first default firmware 411 of the first image chip 41, so that the N-1 copy images 4111 are respectively transmitted to the N–1second image chips 42.

After the transfer step S14, the image processing method further includes the following steps:

A first image capture step S13 is implemented by executing the first default firmware 411 of the first image chip 41 to crop the source screen AX according to a first preset coordinate region, so as to capture a first screen image 4112.
A first output step S14 is implemented by executing the first default firmware 411 of the first image chip 41, so as to output the first screen image 4112 to one of the output screens 3 connected to the first image chip 41.

After the transfer step S12, the image processing method further includes the following steps:

Executing the image processing program N–1 number of times through a second default firmware 421 of the N–1 second image chips 42. Each time the image processing program is executed, the image processing program includes the following steps:
A second image capture step S15 is implemented by executing a second default firmware 421 of one of the N–1second image chips 42 to crop a corresponding one of the N-1copy images 4111, so as to capture a second screen image 422 according to a second preset coordinate region.
A second output step S16 is implemented by executing the second default firmware 421 of the second image chip 42, so that the second screen image 422 is configured to be output to one of the output screens 3 that is connected to the second image chip 42.

The second preset coordinate region in (N−1)th second image capture step S15 and the first preset coordinate region in the first image capture step S13 do not overlap with each other. The first screen image 4112 and the N-1second screen images 422 corresponding to the first output step S14 and (N-1)th second output step S16 are output to the N output screens, and the N output screens display N number of game images.

In the present embodiment, N is 3. In the image copying step S11, the first image chip 41 will copy the source screen AX and generate two copy images 4111. In the transfer step S12, the two copy images 4111 will be transferred to the two second image chips 42. By virtue of the design of the steps, the screen images finally presented by the three output screens 3 included in the game system 100 will come from the first image chip 41 and the two second image chips 42, respectively.

It should be emphasized that the first default firmware 411 of the first image chip 41 in the first image capture step S13 and the first output step S14 is executed to capture the first screen image 4112 and transmit the first screen image 4112 to the output screen 3. Therefore, in practice, unless the first default firmware 411 is rewritten, the first screen image 4112 is essentially difficult to be tampered with. Similarly, the second default firmware 421 of the second image chip 42 in each of the second image capture step S15 and the second output step S16 is executed to capture the second screen image 422 and transmit the second screen image 422 to the output screen 3. Therefore, in practice, unless the second default firmware 421 is rewritten, the second screen image 422 is essentially difficult to be tampered with. It should be noted that, in conventional technology, it is generally difficult for a third party (i.e., one who is not the manufacturer of the game system 100 or the image chip) to modify the firmware within the image chip.

As described above, by virtue of the steps implemented by using the first default firmware 411 of the first image chip 41 and the second default firmware 421 of the second image chip 42, the images viewed by the gamers on each of the output screens 3 can be ensured to be less likely to be tampered with during the transmission process, so as to ensure the fairness and impartiality of the game.

As mentioned above, since the first screen image 4112 is cropped from the first preset coordinate region in the source screen AX by the first default firmware 411, unless the source screen AX is obtained and the first preset coordinate region is known, the first screen image 4112 displayed by the output screen 3 will be difficult to be tampered with. Similarly, each of the second screen images 422 is cropped from the second preset coordinate region in the source screen AX by the second default firmware 421. Therefore, unless the source screen AX is obtained and the second preset coordinate region of each of the second image chips 42 is known, the second screen images 422 displayed on the output screen 3 will be difficult to be tampered with.

It should be emphasized that the game system 100 in actual application is not limited to include the output screen 3. In different embodiments, the game system 100 may also include other auxiliary screens, and the auxiliary screens may display any images and contents as required. In other words, the image displayed on the output screen 3 is mainly the image output by the processing device 4 after executing the image copying step S11, the transfer step S12, the first image capture step S13, the first output step S14, the second image capture step S15 and the second output step S16, while the image displayed on the auxiliary screen is not the image generated after the above-mentioned process steps.

It is worth mentioning that the processing device 4 of the game system 100 in practice may also be manufactured or sold independently. In other words, the processing device 4 of the game system 100 in the present disclosure may be separate from the main body 1, the input device 2, and the output screen 3 of the game system 100, and may be manufactured and sold independently.

Naturally, the processing device 4 of the game system 100 in the present disclosure may further include a plurality of video connectors (e.g., High-Definition Multimedia Interface connectors, DisplayPort connectors, etc.). Accordingly, relevant admins can utilize the video connectors, so that the processing device 4 is able to receive the source screen AX and transmit images to the output screens 3.

In one embodiment, the first preset coordinate region may be surrounded by four first coordinates, and one of the four first coordinates is a first starting coordinate that is preset. Before the first image capture step S13, the image processing method further includes a first resolution reading step implemented by using the first image chip 41 to read extended display identification data (i.e., EDID) of the output screen connected thereto, so as to obtain a first resolution of the output screen and calculating, by the first image chip 41, the remaining three of the four first coordinates corresponding to the first preset coordinate region based on the first resolution and the first starting coordinate. The second preset coordinate region is surrounded by four second coordinates, and one of the four second coordinates is a second starting coordinate that is preset. Before the second image capture step S15, the image processing method further includes a second resolution reading step implemented by using the second image chip 42 to read extended display identification data (i.e., EDID) of the output screen connected thereto, so as to obtain a second resolution of the output screen and calculating, by the second image chip 42, the remaining three of the four second coordinates corresponding to the second preset coordinate region based on the second resolution and the second starting coordinate.

In one variation of the present embodiments, between the first image capture step S13 and the first output step S14, the image processing method further includes the following steps:

A conversion step is implemented by performing an image scaling process on the first screen image 4112 according to a resolution of one of the output screens 3 connected to the first image chip 41 and the first preset coordinate region, so that the first screen image 4112 is configured to conform to the resolution of the output screen 3 connected to the first image chip 41 and is configured to be displayed on the output screen 3.

For example, in one embodiment, assuming that in the first image capture step S13, the first screen image 4112 captured by the first image chip 41 has a pixel resolution of 2560×1440, and the output screen 3 connected to the first image chip 41 has a pixel resolution of 1920×1080, then after the first image capture step S13, the first default firmware 411 of the first image chip 41 will perform the conversion step to carry out an image scaling process on the first screen image 4112. Accordingly, the pixel resolution of the first screen image 4112 can be converted from 2560×1440 to 1920×1080. Thereafter, the first default firmware 411 of the first image chip 41 will execute the first output step S14.

Similarly, in one variation of the present embodiments, between the second image capture step S15 and the second output step S16 each time the image processing program is executed, the image processing method further includes the following steps: a conversion step is implemented by performing an image scaling process on the second screen image 422 according to a resolution of the output screen 3 connected to the second image chip 42 and the second preset coordinate region, so that the second screen image 422 is configured to conform to the resolution of the output screen 3 connected to the second image chip 42 and is configured to be displayed on the output screen 3.

In summary, by virtue of the image copying step, the transfer step, the first image capture step, the first output step, the second image capture step, and the second output step, the game system, the image processing method, and the processing device in the present disclosure can be ensured to be less likely to be tampered with during the transmission process, so that the fairness and impartiality of the game can be ensured.

It should be specifically noted that, in conventional technology, when the internal display chip of the central processing device of the game system only supports output to four screens, but the relevant admins intend to connect five screens to the game system, an additional discrete graphics card must be purchased. However, a cost of the game system will be increased.

Based on the above example, by virtue of the processing device 4, the relevant admins can use the game system 100 or the processing device 4 of the present disclosure to connect the central processing device 5 to the three screens and connect the central processing device 5 to the processing device 4 of the present disclosure. Assuming that the processing device 4 is equipped with one first image chip 41 and two second image chips 42, the processing device 4 can support up to three additional screen connections. In this way, the game system 100 can support output to six screens without the need to purchase an additional discrete graphics card.

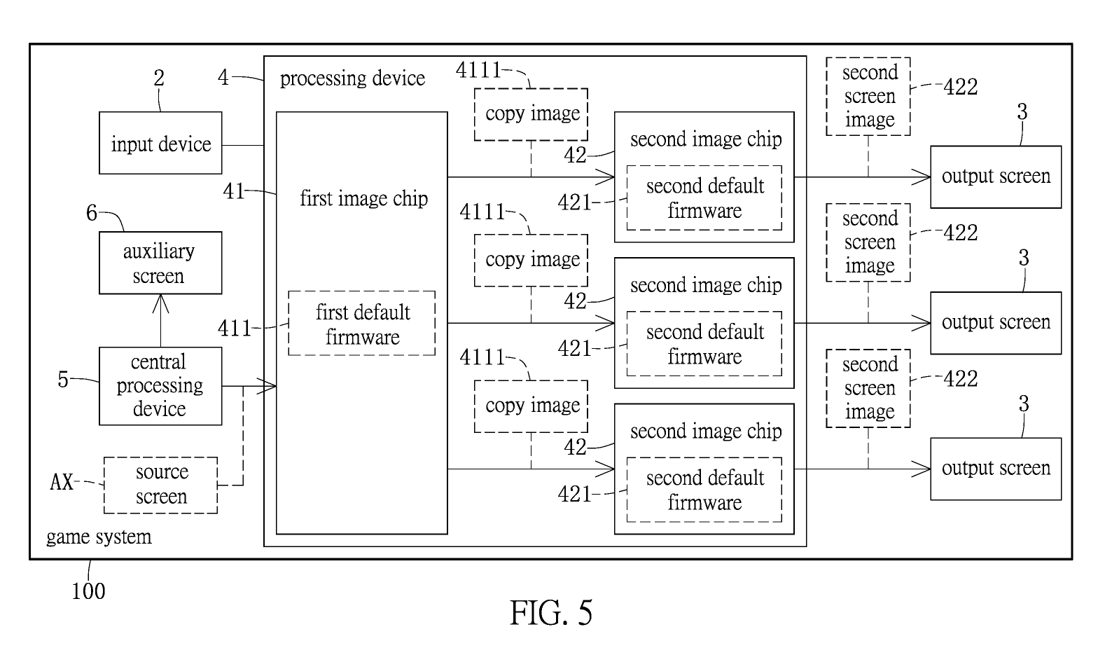

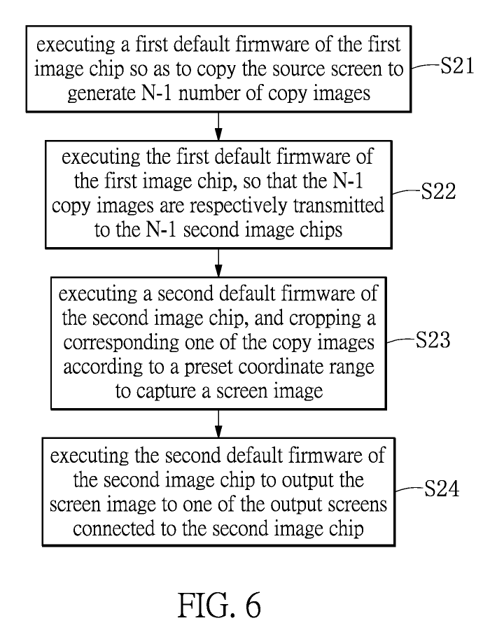

Referring to FIGS. 5 and 6, FIG. 5 is a block diagram of the game system according to a second embodiment of the present disclosure, and FIG. 6 is a flowchart of the image processing method for the game system according to the second embodiment of the present disclosure.

The image processing method of the game system of the present embodiment includes the following steps:

An image copying step S21 is implemented by executing a first default firmware 411 of the first image chip 41 so as to copy the source screen to generate N-1number of copy images 4111.
A transfer step S22 is implemented by executing the first default firmware 411 of the first image chip 41, so that the N-1 copy images 4111 are respectively transmitted to the N–1 second image chips 42. After the transfer step S22, the image processing method further includes the following steps:

Executing N times the image processing program through N second image chips 42. Each time the image processing program is executed, the image processing program includes:

An image capturing step S23 is implemented by executing a second default firmware 421 of the second image chip 42, and cropping a corresponding one of the copy images 4111 according to a preset coordinate range to capture a screen image.
An output step S24 is implemented by executing the second default firmware 421 of the second image chip 42 to output the screen image to one of the output screens 3 connected to the second image chip 42.

The N number of second preset coordinate regions do not overlap with each other. The N second screen images 422 are output to the N output screens 3, and the N output screens 3 display the N game images A1.

In the present embodiment, N is 3. That is to say, the game system 100 includes three output screens 3, the processing device 4 includes three second image chips 42, and the three output screens 3 are connected to the three second image chips 42 in a one-to-one manner. In the image copying step S21, the first image chip 41 will generate three copy images 4111.

As shown in FIGS. 5 and 6, the first image chip 41 only copies the source screen and transmits the copy image 4111 to each second image chip 42, and the first image chip 41 does not perform the first image capture step S13 and the first output step S14 in the above-mentioned embodiment. That is, the first image chip 41 in the present embodiment does not transmit the output image to the output screen 3. In other words, the images of the three output screens 3 included in the game system 100 of the present embodiment come from the three second image chips 42, and the images of the output screen 3 do not come from the first image chip 41.

In one variation of the present embodiment, the image processing program may further include a conversion step between the image capture step S23 and the output step S24. The conversion step is to perform an image scaling process on the second screen image 422 according to a resolution of the output screen 3 connected to the second image chip 42 and the second preset coordinate region, so that the second screen image 422 is configured to conform to the resolution of the output screen 3 connected to the second image chip 42 and is configured to be displayed on the output screen 3.

It should be noted that the processing device of the game system exemplified in the present embodiment may also be manufactured or sold independently, and the processing device of the game system is not limited to being manufactured or sold together with the main body 1 and the input device 2.

### Beneficial Effects of the Embodiments

In conclusion, in the image processing method, the game system, and the processing device, provided by the present disclosure, by virtue of “the first image chip, the second image chip, the image copying step, the transfer step, the first image capture step, the first output step, the second image capture step, and the second output step,” the image processing method, the game system, and the processing device can ensure that the game images presented by each of the output screens of the game system are not easily tampered with, so as to ensure the fairness and impartiality of the game.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An image processing method for a game system, applicable to be executed by a processing device of the game system, wherein the game system includes N number of output screens, and N is a positive integer greater than 1, wherein the processing device includes a first image chip and N–1 number of second image chips, wherein the first image chip is electrically connected to each of the N–1 second image chips, wherein the processing device is configured to execute the image processing method upon receiving a source screen including N number of game images that do not overlap with each other, and wherein the image processing method comprises:
an image copying step implemented by executing a first default firmware of the first image chip so as to copy the source screen to generate N-1 number of copy images;
a transfer step implemented by executing the first default firmware of the first image chip, so that the N-1 copy images are respectively transmitted to the N–1 second image chips;
wherein, after the transfer step, the image processing method further includes:
a first image capture step implemented by executing the first default firmware of the first image chip to crop the source screen according to a first preset coordinate region, so as to capture a first screen image; and
a first output step implemented by executing the first default firmware of the first image chip, so as to output the first screen image to one of the output screens connected to the first image chip;
wherein, after the transfer step, the image processing method further includes:
executing the image processing program N–1 number of times through a second default firmware of the N–1 second image chips, wherein each time the image processing program is executed, the image processing program includes:
a second image capture step implemented by executing a second default firmware of one of the N–1 second image chips to crop a corresponding one of the N-1 copy images, so as to capture a second screen image according to a second preset coordinate region; and
a second output step implemented by executing the second default firmware of the second image chip, so that the second screen image is configured to be output to one of the output screens that is connected to the second image chip;
wherein the second preset coordinate region in (N−1)th second image capture step and the first preset coordinate region in the first image capture step do not overlap with each other; wherein the first screen image and the N-1 second screen images corresponding to the first output step and (N-1)th second output step are output to the N output screens, and the N output screens display N number of game images.

2. The image processing method according to claim 1, wherein, between the first image capture step and the first output step, the image processing method further includes:
a conversion step implemented by performing an image scaling process on the first screen image according to a resolution of one of the output screens connected to the first image chip and the first preset coordinate region, so that the first screen image is configured to conform to the resolution of the output screen connected to the first image chip and is configured to be displayed on the output screen.

3. The image processing method according to claim 1, wherein, between the second image capture step and the second output step each time the image processing program is executed, the image processing method further includes:
a conversion step implemented by performing an image scaling process on the second screen image according to a resolution of the output screen connected to the second image chip and the second preset coordinate region, so that the second screen image is configured to conform to the resolution of the output screen connected to the second image chip and is configured to be displayed on the output screen.

4. The image processing method according to claim 1, wherein the first preset coordinate region is surrounded by four first coordinates, and one of the four first coordinates is a first starting coordinate that is preset; wherein, before the first image capture step, the image processing method further includes a first resolution reading step implemented by using the first image chip to read extended display identification data of the output screen connected thereto, so as to obtain a first resolution of the output screen and calculating, by the first image chip, the remaining three of the four first coordinates corresponding to the first preset coordinate region based on the first resolution and the first starting coordinate; wherein the second preset coordinate region is surrounded by four second coordinates, and one of the four second coordinates is a second starting coordinate that is preset; and wherein, before the second image capture step, the image processing method further includes a second resolution reading step implemented by using the second image chip to read extended display identification data of the output screen connected thereto, so as to obtain a second resolution of the output screen and calculating, by the second image chip, the remaining three of the four second coordinates corresponding to the second preset coordinate region based on the second resolution and the second starting coordinate.

5. A game system, comprising:
a main body;
a central processing device including an internal display chip;
at least one input device disposed on the main body, wherein the at least one input device is configured to be used to provide user operation;
N number of output screens disposed in the main body, wherein N is a positive integer greater than 1;
a processing device electrically connected to the central processing device, wherein the processing device includes:
a first image chip configured to receive a source screen transmitted by the central processing device; wherein the source screen includes N number of game images that do not overlap with each other; and
N-1 number of second image chips, wherein each of the N-1 second image chips is electrically connected to the first image chip;
wherein one of the N output screens is connected to the first image chip, and N-1 number of output screens are respectively connected to the N–1 second image chips;
wherein, after receiving the source screen, the processing device is configured to include:
an image copying step implemented by executing a first default firmware of the first image chip so as to copy the source screen to generate N-1 number of copy images;
a transfer step implemented by executing the first default firmware of the first image chip, so that the N-1 copy images are respectively transmitted to the N–1 second image chips;
wherein, after the transfer step, the processing device further includes:
a first image capture step implemented by executing the first default firmware of the first image chip to crop the source screen according to a first preset coordinate region, so as to capture a first screen image; and
a first output step implemented by executing the first default firmware of the first image chip, so as to output the first screen image to one of the output screens connected to the first image chip;
wherein, after the transfer step, the processing device further includes:
executing the image processing program N–1 number of times through a second default firmware of the N–1 second image chips, wherein each time the image processing program is executed, the image processing program includes:
a second image capture step implemented by executing a second default firmware of one of the N–1 second image chips to crop a corresponding one of the N-1 copy images, so as to capture a second screen image according to a second preset coordinate region; and
a second output step implemented by executing the second default firmware of the second image chip, so that the second screen image is configured to be output to one of the output screens that is connected to the second image chip;
wherein the second preset coordinate region in (N−1)th second image capture step and the first preset coordinate region in the first image capture step do not overlap with each other; wherein the first screen image and the N-1 second screen images corresponding to the first output step and (N-1)th second output step are output to the N output screens, and the N output screens display N number of game images.

6. The game system according to claim 5, wherein, between the first image capture step and the first output step, the processing device further includes:
a conversion step implemented by performing an image scaling process on the first screen image according to a resolution of one of the output screens connected to the first image chip and the first preset coordinate region, so that the first screen image is configured to conform to the resolution of the output screen connected to the first image chip and is configured to be displayed on the output screen.

7. The game system according to claim 5, wherein, between the second image capture step and the second output step each time the image processing program is executed, the processing device further includes:
a conversion step implemented by performing an image scaling process on the second screen image according to a resolution of the output screen connected to the second image chip and the second preset coordinate region, so that the second screen image is configured to conform to the resolution of the output screen connected to the second image chip and is configured to be displayed on the output screen.

8. The game system according to claim 5, wherein the first preset coordinate region is surrounded by four first coordinates, and one of the four first coordinates is a first starting coordinate that is preset; wherein, before the first image capture step, the processing device further includes a first resolution reading step implemented by using the first image chip to read extended display identification data of the output screen connected thereto, so as to obtain a first resolution of the output screen and calculating, by the first image chip, the remaining three of the four first coordinates corresponding to the first preset coordinate region based on the first resolution and the first starting coordinate; wherein the second preset coordinate region is surrounded by four second coordinates, and one of the four second coordinates is a second starting coordinate that is preset; and wherein, before the second image capture step, the processing device further includes a second resolution reading step implemented by using the second image chip to read extended display identification data of the output screen connected thereto, so as to obtain a second resolution of the output screen and calculating, by the second image chip, the remaining three of the four second coordinates corresponding to the second preset coordinate region based on the second resolution and the second starting coordinate.

9. The game system according to claim 5, further comprising at least one auxiliary screen, wherein the central processing device is electrically connected to the at least one auxiliary screen, and is configured to cause the at least one auxiliary screen to display one of the N game images different from the source screen.

10. A processing device for a game system, applicable to be executed by a processing device of the game system, wherein the processing device of the game system is electrically connected to N number of output screens of the game system, and the processing device of the game system comprises:
a first image chip configured to receive a source screen, wherein the source screen includes N number of game images that do not overlap with each other;
N-1 number of second image chips, wherein each of the N-1 second image chips is electrically connected to the first image chip;
wherein one of the N output screens is connected to the first image chip, and N-1 number of output screens are respectively connected to the N–1 second image chips;
wherein, after receiving the source screen, the processing device is configured to include:
an image copying step implemented by executing a first default firmware of the first image chip so as to copy the source screen to generate N-1 number of copy images;
a transfer step implemented by executing the first default firmware of the first image chip, so that the N-1 copy images are respectively transmitted to the N–1 second image chips;
wherein, after the transfer step, the processing device further includes:
a first image capture step implemented by executing the first default firmware of the first image chip to crop the source screen according to a first preset coordinate region, so as to capture a first screen image; and
a first output step implemented by executing the first default firmware of the first image chip, so as to output the first screen image to one of the output screens connected to the first image chip;
wherein, after the transfer step, the processing device further includes:
executing the image processing program N–1 number of times through a second default firmware of the N–1 second image chips, wherein each time the image processing program is executed, the image processing program includes:
a second image capture step implemented by executing a second default firmware of one of the N–1 second image chips to crop a corresponding one of the N-1 copy images, so as to capture a second screen image according to a second preset coordinate region; and
a second output step implemented by executing the second default firmware of the second image chip, so that the second screen image is configured to be output to one of the output screens that is connected to the second image chip;
wherein the second preset coordinate region in (N−1)th second image capture step and the first preset coordinate region in the first image capture step do not overlap with each other; wherein the first screen image and the N-1 second screen images corresponding to the first output step and (N-1)th second output step are output to the N output screens, and the N output screens display N number of game images.
